(19) United States
(12) Patent Application Publication
(10) Pub. No.: US 2003/0233590 A1
(43) Pub. Date: Dec. 18, 2003

(54) Conversion device bult in with signal and level conversion circuits

(76) Inventor: Henry Liu, Taipei Hsien (TW)

Correspondence Address: Hedman & Costigan, P.C., 1185 Avenue of the Americas, New York, NY, 10036-2646, US

(21) Appl. No.: 10/173,254

(22) Filed: Jun. 17, 2002

(51) Int. Cl. G06F 1/26

(52) U.S. Cl. 713/300

(57) ABSTRACT

A conversion device built in with a signal conversion circuit and a level conversion circuits is provided. The signal conversion circuit is used to convert data transfer signals between a host computer and a portable device, and the level conversion circuit can be used for fast charging of the portable device using a power supply from the host computer. The signal conversion circuit supports a data link between two communicating devices with different I/O interfaces. The signal conversion circuit further incorporates a microprocessor controller with differential input for receiving data signals at the first voltage level and outputting data signals at the second voltage level in the data transfer process. The level conversion circuit includes a power adaptor that can make use of the physical cable connection to fast recharge the portable device using the power supply from the host computer.

### BACKGROUND OF THE INVENTION

1. Field of the Invention

The present invention relates to a conversion device that can be used for establishing a data link between a host computer and a portable device, and fast recharging of the portable device, in particular, a conversion device that can make data transfer between two communicating devices with different power specifications, where the host computer could be a desktop or notebook and the portable device could be a mobile phone or a personal digital assistant (PDA).

2. Description of Related Arts

In the contemporary society, mobile phones and PDAs are widely used by people at all levels. Most of these portable devices now have some kind of data transfer capabilities for downloading from a host computer by means of a special kind of conversion device. For example, in the conventional way, a PDA is able to establish a data link with a notebook computer through its RS232 serial port either for uploading, downloading, or control functions. Through the conversion device, input data signals received from the terminal of the first device is converted and output to the second device terminal which operates at a different voltage level. FIG. 5 is the block diagram of a conventional conversion device, through which a data link between a host computer and a portable device is established through the RS232 port, and data can be transferred in both directions. Since these two communicating devices each are operating independently with different power specifications, a conventional RS232 data cable is not operable because it cannot provide the voltage level for the host computer to determine the voltage differential of input signals received from the portable device. An external power input is normally required for a level conversion circuit to change the voltage level of data signals from the portable device to the level of the host computer through its TTL/CMOS transistor buffers. This power source would have to come from an external power source by a power adapter. Such a configuration of the conversion device with multiple power inputs is likely to degrade the quality of data link between two communicating devices, besides additional cost considerations. If the conversion device is to possess recharging capability another power adapter is needed, which also creates a burden to carry the device around.

In sum, it is apparent that the conventional level conversion device is not cost effective, not convenient to carry nor reliable in the data link.

### SUMMARY OF THE INVENTION

The main object of the present invention is to provide a conversion device comprising a signal conversion circuit and a power level conversion circuit coupled between the host computer and a portable device. The power level conversion circuit is capable of supplying power from the host computer to the portable device for fast recharging of the portable device. The conversion device is capable of supporting reliable data transfer between two communicating devices with different I/O interfaces, which could be either a USB or an RS232.

The conversion device in accordance with the invention comprises a signal conversion circuit and a power level conversion circuit both housed in the conversion device. The signal conversion circuit connected between the portable device interface and the computer interface includes a microprocessor, through which data link can be established between two communicating devices. Data signals from the first device are converted by the microprocessor and passed to the second device in the data transfer process, or vice versa. The power adaptor in the power level conversion circuit is used for fast charging the portable device using the power supply from the host computer. The power adapter can also be effectively controlling the power output from the host computer to within 450-500 mA to meet the power specifications of USB connector (5V, 500 mA).

The features and structure of the present invention will be more clearly understood when taken in conjunction with the accompanying figures.

### BRIEF DESCRIPTION OF THE DRAWINGS

FIG. 1 is a detailed a schematic diagram in accordance with the invention showing blocks of a signal conversion circuit and a power level conversion circuit;

FIG. 2 is a block diagram of the operation of the conversion device of a preferred embodiment;

FIG. 3 is the external structure of the conversion device of the first preferred embodiment;

FIG. 4 is the external structure of the conversion device of the second preferred embodiment; and

FIG. 5 is the block diagram of the operation of a conventional conversion device.

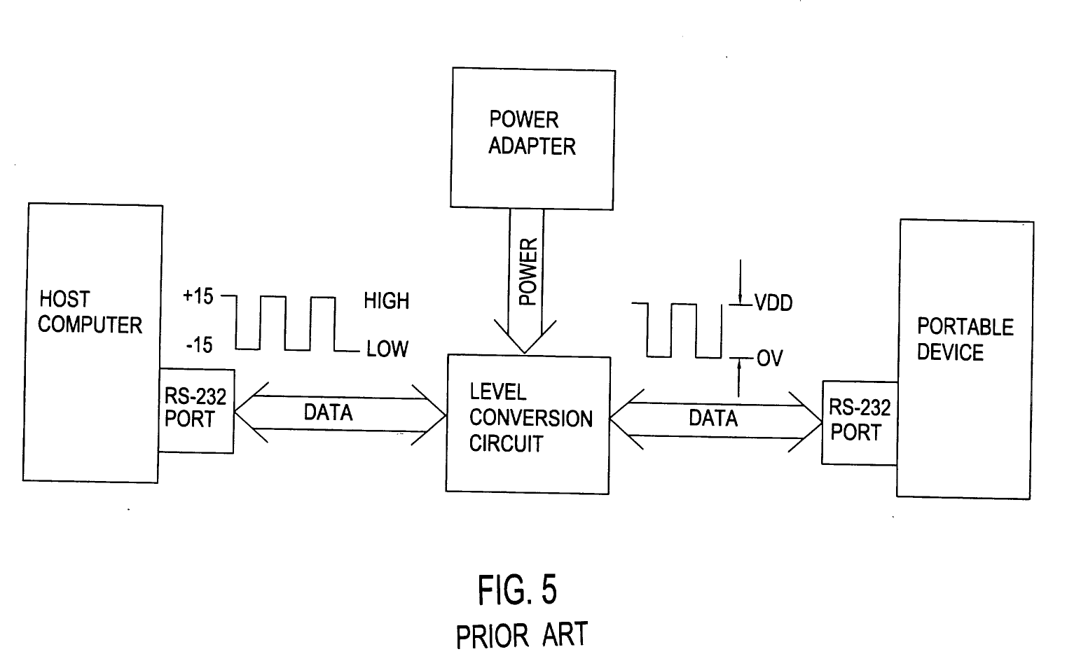

### DETAILED DESCRIPTION OF THE PREFERRED EMBODIMENT

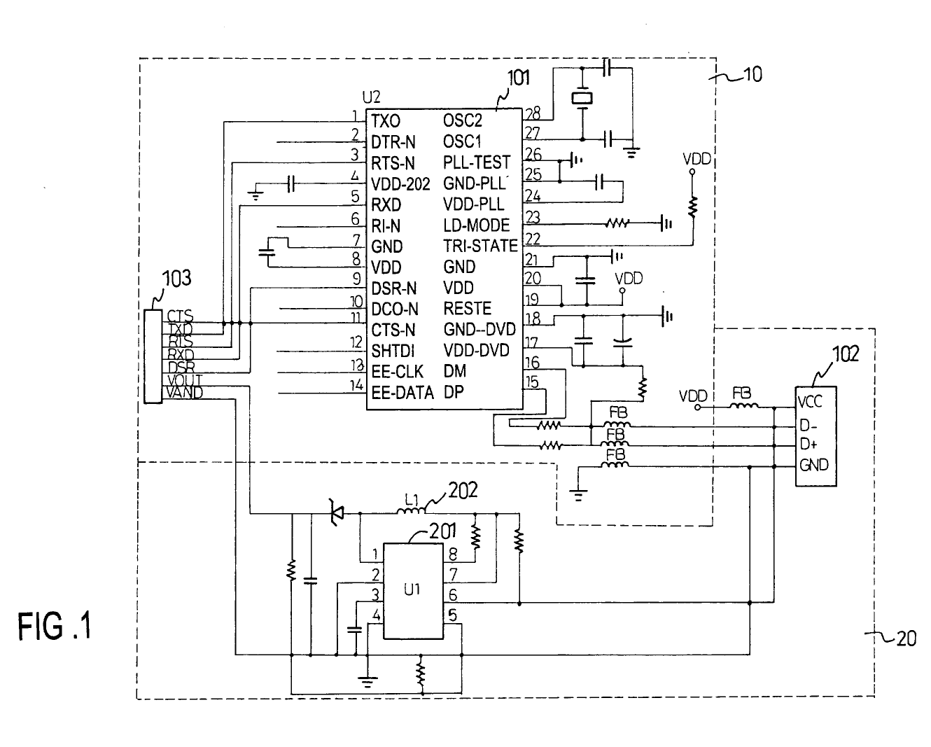

FIG. 1 is a detailed schematic diagram of the conversion device in accordance with the invention. The conversion device mainly comprises a signal conversion circuit (10) having a microprocessor (101) and a power level conversion circuit (20) having a power adapter (201).

The microprocessor (101) in the signal conversion circuit (10) is connected between the computer interface (102) and the device interface (103) designed to convert data signals in between two communicating devices. The power adapter (201) in the power level conversion circuit (20) is connected to the VCC and GND of a computer interface (102) and a device interface (103) for power regulation and fast recharging of the portable device. The power output of the power adapter (201) is connected with a choke coil (202) to the power input of device interface (103).

The computer interface (102) is equipped with a USB connector and the device interface (103) is an RS232 connector.

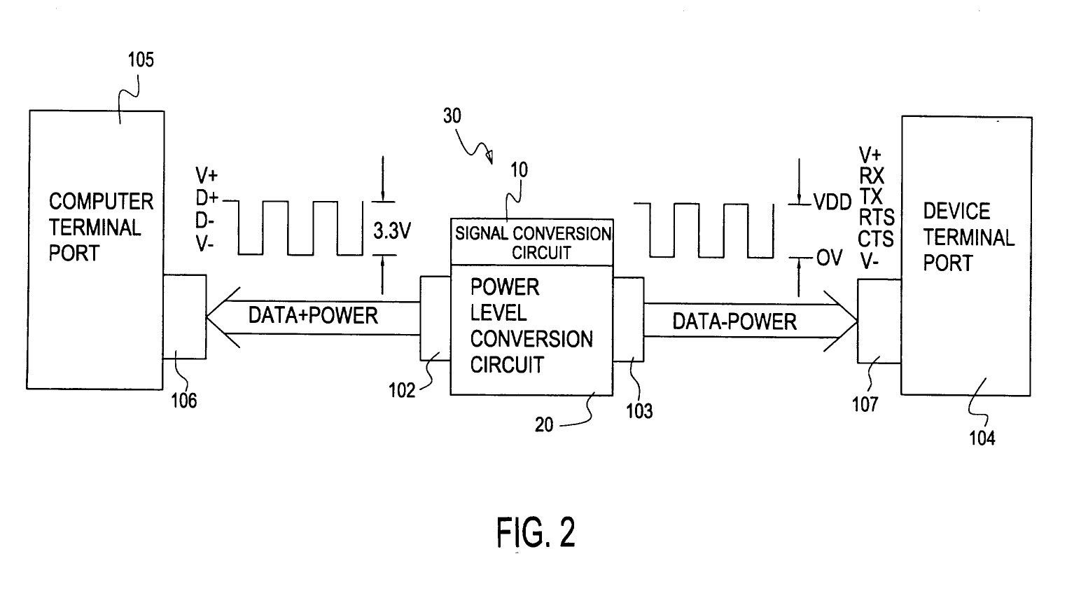

The detailed operation of the conversion device in accordance with the invention is described below. FIG. 2 is a block diagram showing the data operation of the conversion device of a preferred embodiment between two communicating devices. The computer interface (102) is a USB connector, and the device interface (103) is an RS232 protocol connector. To establish physical connection, the computer terminal port (105) through a USB connector (106) is linked to the device terminal port (104) on the other end through an RS232 connector (107), with the conversion device (30) acting as a buffer between them. Through the RS232 connector the device terminal port (104) of the portable device is able to draw power from the computer terminal port (105) by means of the power adapter (201) in the power level conversion circuit (20) for fast recharging. The host computer outputs signals in logical level, ex. +/−3.3V through the computer interface (102) to the microprocessor (101) of the signal conversion circuit (10), which will be used for determining the voltage differential of input signals and converting to the appropriate voltage level of the portable device.

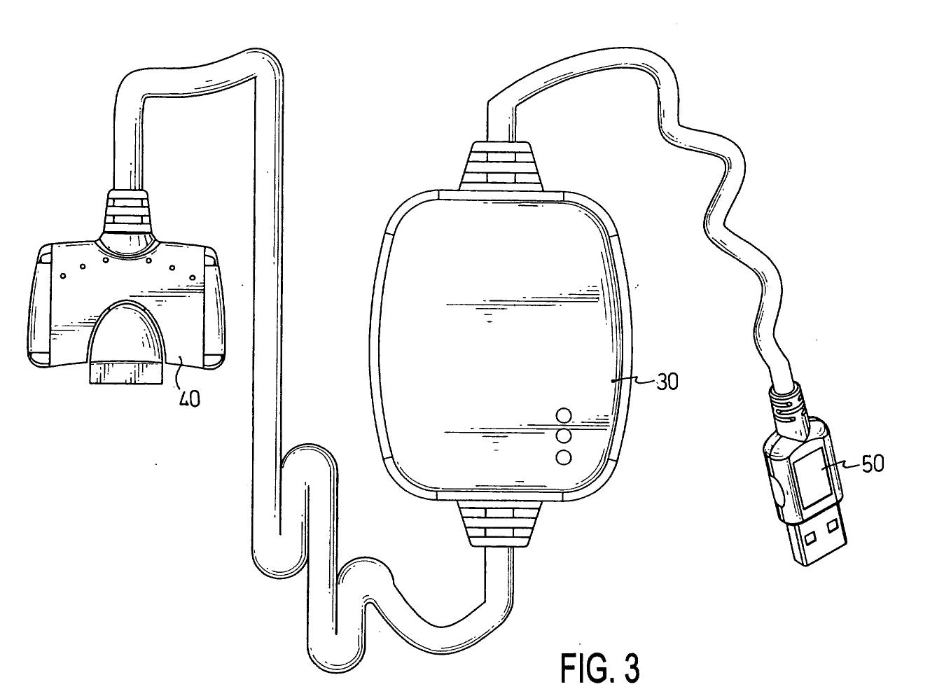

FIG. 3 shows the external structure of the conversion device of the first preferred embodiment in accordance with the invention. The structure of the conversion device (30) shows a USB cable connector (50), corresponding to the computer interface (102) in another example mentioned above, is for making connection to the host computer end, and an RS232 cable connector (40), corresponding to the device interface (103), is for making connection to the portable device end. The signal conversion circuit (10) and the power level conversion circuit (20) are both detached and housed in the conversion device (30) in between two opposing cable connectors (40, 50).

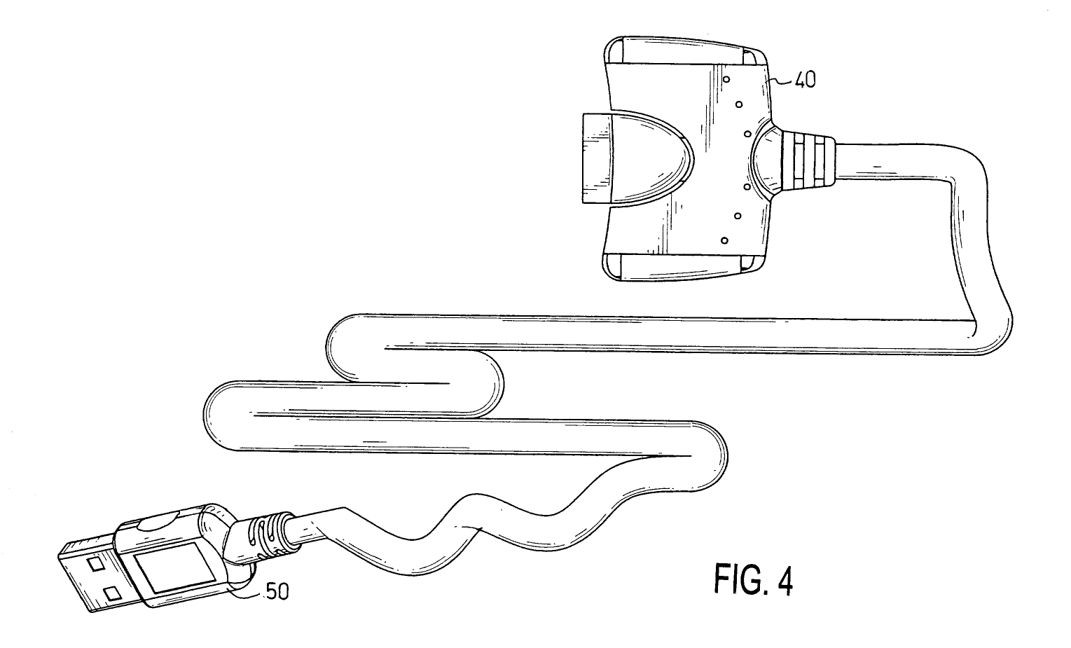

FIG. 4 shows the external structure of the conversion device of the second preferred embodiment, which also has a USB cable connector (40) on one end and an RS232 cable connector (50) on the other end. The signal conversion circuit (10) and the power level conversion circuit (20) of the conversion device (30) are housed in the USB cable connector (50) in this example.

The main feature of the present invention is that the design of the conversion device allows a computer with a USB interface and a portable device with an RS232 interface to establish a data link in both directions with no need for an external power adapter.

The foregoing description of the preferred embodiments of the present invention is intended to be illustrative only and, under no circumstances, should the scope of the present invention be so restricted.

What is claimed is:

1. A conversion device built in with signal and power level conversion circuits comprising:
a signal conversion circuit with a microprocessor;
a power level conversion circuit including a power adapter; wherein the signal conversion circuit connected between a computer interface and a device interface is for converting and passing on data signals in data transfer between a host computer and a portable device through a computer interface and a device interface; and the power level conversion circuit also connected between the computer interface and the device interface is for fast recharging of the portable device.

2. The conversion device built in with signal and power level conversion circuits as claimed in claim 1, wherein a power output of the power level conversion circuit is connected with a choke coil to the power input of the device interface.

3. The conversion device built in with signal and power level conversion circuits as claimed in claim 1, wherein the device interface is connected through a RS232 protocol connector to a portable device and the computer interface is connected through a USB connector to a host computer.

4. The conversion device built in with signal and power level conversion circuits as claimed in claim 1, wherein the signal conversion circuit and the power level conversion circuit are detached and housed in the conversion device electrically connecting between the cable USB connector on one end and the RS232 cable connector on another end.

5. The conversion device built in with signal and power level conversion circuits as claimed in claim 1, wherein the signal conversion circuit and the power level conversion circuit are housed in the RS232 cable connector on one end and electrically connected to the USB cable connector on the other end of the cable.
